(19) United States
(12) Patent Application Publication
(10) Pub. No.: US 2024/0048174 A1
(43) Pub. Date: Feb. 8, 2024

(54) FREQUENCY HOPPING FOR SOUNDING REFERENCE SIGNAL TRANSMISSION

(71) Applicant: QUALCOMM Incorporated, San Diego, CA (US)

(72) Inventors: Yitao CHEN, San Diego, CA (US); Mostafa KHOSHNEVISAN, San Diego, CA (US); Muhammad Sayed Khairy ABDELGHAFFAR, San Jose, CA (US)

(21) Appl. No.: 17/817,608

(22) Filed: Aug. 4, 2022

(51) Int. Cl. H04B 1/7143; H04L 5/00

(52) U.S. Cl. CPC H04B 1/7143; H04L 5/0048

(57) ABSTRACT

Various aspects of the present disclosure generally relate to wireless communication. In some aspects, a user equipment (UE) may receive configuration information associated with configuring a set of sounding reference signal (SRS) transmissions on a set of frequencies, wherein the set of SRS transmissions on the set of frequencies comprise an SRS frequency hopping pattern. The UE may transmit the set of SRS transmissions on the set of frequencies in accordance with the SRS frequency hopping pattern. Numerous other aspects are described.

### FIELD OF THE DISCLOSURE

Aspects of the present disclosure generally relate to wireless communication and to techniques and apparatuses for frequency hopping for sounding reference signal transmission.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving configuration information associated with configuring a set of sounding reference signal (SRS) transmissions on a set of frequencies, wherein the set of SRS transmissions on the set of frequencies comprise an SRS frequency hopping pattern. The method may include transmitting the set of SRS transmissions on the set of frequencies in accordance with the SRS frequency hopping pattern.

Some aspects described herein relate to a method of wireless communication performed by a network node. The method may include transmitting configuration information associated with configuring a set of SRS transmissions on a set of frequencies, wherein the set of SRS transmissions on the set of frequencies comprise an SRS frequency hopping pattern. The method may include receiving the set of SRS transmissions on the set of frequencies in accordance with the SRS frequency hopping pattern.

Some aspects described herein relate to a UE for wireless communication. The user equipment may include a memory and one or more processors coupled to the memory. The one or more processors may be configured to receive configuration information associated with configuring a set of SRS transmissions on a set of frequencies, wherein the set of SRS transmissions on the set of frequencies comprise an SRS frequency hopping pattern. The one or more processors may be configured to transmit the set of SRS transmissions on the set of frequencies in accordance with the SRS frequency hopping pattern.

Some aspects described herein relate to a network node for wireless communication. The network node may include a memory and one or more processors coupled to the memory. The one or more processors may be configured to transmit configuration information associated with configuring a set of SRS transmissions on a set of frequencies, wherein the set of SRS transmissions on the set of frequencies comprise an SRS frequency hopping pattern. The one or more processors may be configured to receive the set of SRS transmissions on the set of frequencies in accordance with the SRS frequency hopping pattern.

Some aspects described herein relate to a non-transitory computer-readable medium that stores a set of instructions for wireless communication by a UE. The set of instructions, when executed by one or more processors of the UE, may cause the UE to receive configuration information associated with configuring a set of SRS transmissions on a set of frequencies, wherein the set of SRS transmissions on the set of frequencies comprise an SRS frequency hopping pattern. The set of instructions, when executed by one or more processors of the UE, may cause the UE to transmit the set of SRS transmissions on the set of frequencies in accordance with the SRS frequency hopping pattern.

Some aspects described herein relate to a non-transitory computer-readable medium that stores a set of instructions for wireless communication by a network node. The set of instructions, when executed by one or more processors of the network node, may cause the network node to transmit configuration information associated with configuring a set of SRS transmissions on a set of frequencies, wherein the set of SRS transmissions on the set of frequencies comprise an SRS frequency hopping pattern. The set of instructions, when executed by one or more processors of the network node, may cause the network node to receive the set of SRS transmissions on the set of frequencies in accordance with the SRS frequency hopping pattern.

Some aspects described herein relate to an apparatus for wireless communication. The apparatus may include means for receiving configuration information associated with configuring a set of SRS transmissions on a set of frequencies, wherein the set of SRS transmissions on the set of frequencies comprise an SRS frequency hopping pattern. The apparatus may include means for transmitting the set of SRS transmissions on the set of frequencies in accordance with the SRS frequency hopping pattern.

Some aspects described herein relate to an apparatus for wireless communication. The apparatus may include means for transmitting configuration information associated with configuring a set of SRS transmissions on a set of frequencies, wherein the set of SRS transmissions on the set of frequencies comprise an SRS frequency hopping pattern. The apparatus may include means for receiving the set of SRS transmissions on the set of frequencies in accordance with the SRS frequency hopping pattern.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical channels and reference signals in a wireless network, in accordance with the present disclosure.

FIG. 5 is a diagram illustrating an example of sounding reference signal (SRS) resource sets, in accordance with the present disclosure.

FIG. 6 is a diagram illustrating an example of an SRS bandwidth configuration, in accordance with the present disclosure.

FIG. 7 is a diagram illustrating an example of frequency hopping and repetition, in accordance with the present disclosure.

FIGS. 8 and 9 are diagrams illustrating examples of SRS partial frequency sounding, in accordance with the present disclosure.

FIG. 10 is a diagram illustrating an example of coherent joint transmission operation, in accordance with the present disclosure.

FIGS. 11A-11D are diagrams illustrating an example associated with frequency hopping for sounding reference signal transmission, in accordance with the present disclosure.

FIG. 12 is a diagram illustrating an example process performed, for example, by a UE, in accordance with the present disclosure.

FIG. 13 is a diagram illustrating an example process performed, for example, by a network node, in accordance with the present disclosure.

FIG. 14 is a diagram of an example apparatus for wireless communication, in accordance with the present disclosure.

FIG. 15 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

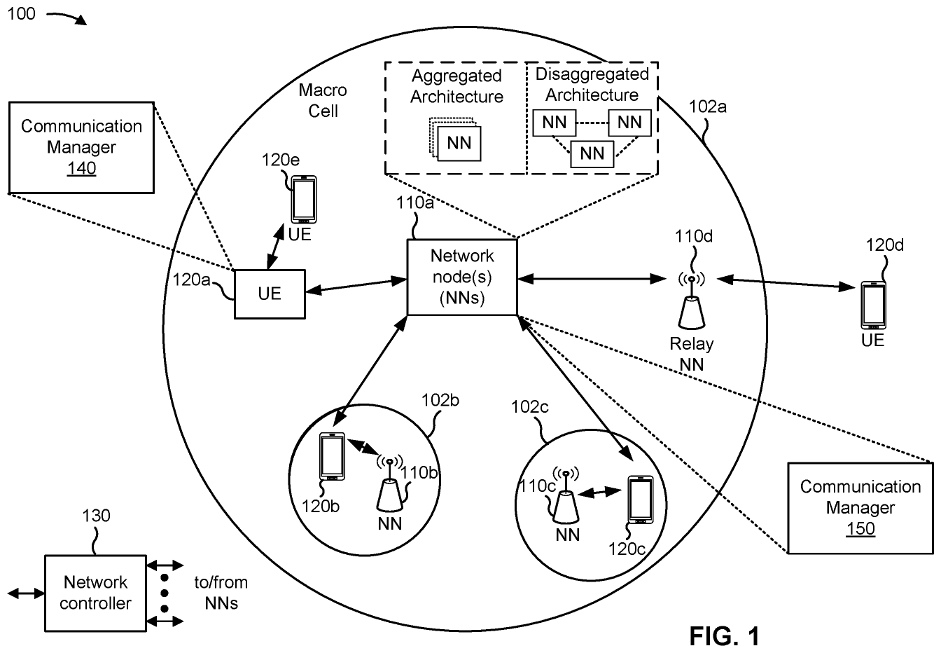

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes. and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices. and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FRI (410 MHz-7.125 GHz) and FR2 (24.25 GHZ-52.6 GHz). It should be understood that although a portion of FRI is greater than 6 GHz. FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz). FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive configuration information associated with configuring a set of sounding reference signal (SRS) transmissions on a set of frequencies, wherein the set of SRS transmissions on the set of frequencies comprise an SRS frequency hopping pattern; and transmit the set of SRS transmissions on the set of frequencies in accordance with the SRS frequency hopping pattern. Additionally, or alternatively, the communication manager 140 may perform one or more other operations described herein.

In some aspects, the network node 110 may include a communication manager 150. As described in more detail elsewhere herein, the communication manager 150 may transmit configuration information associated with configuring a set of SRS transmissions on a set of frequencies, wherein the set of SRS transmissions on the set of frequencies comprise an SRS frequency hopping pattern; and receive the set of SRS transmissions on the set of frequencies in accordance with the SRS frequency hopping pattern. Additionally, or alternatively, the communication manager 150 may perform one or more other operations described herein.

As indicated above, FIG. 1 is provided as an example. Other examples may differ from what is described with regard to FIG. 1.

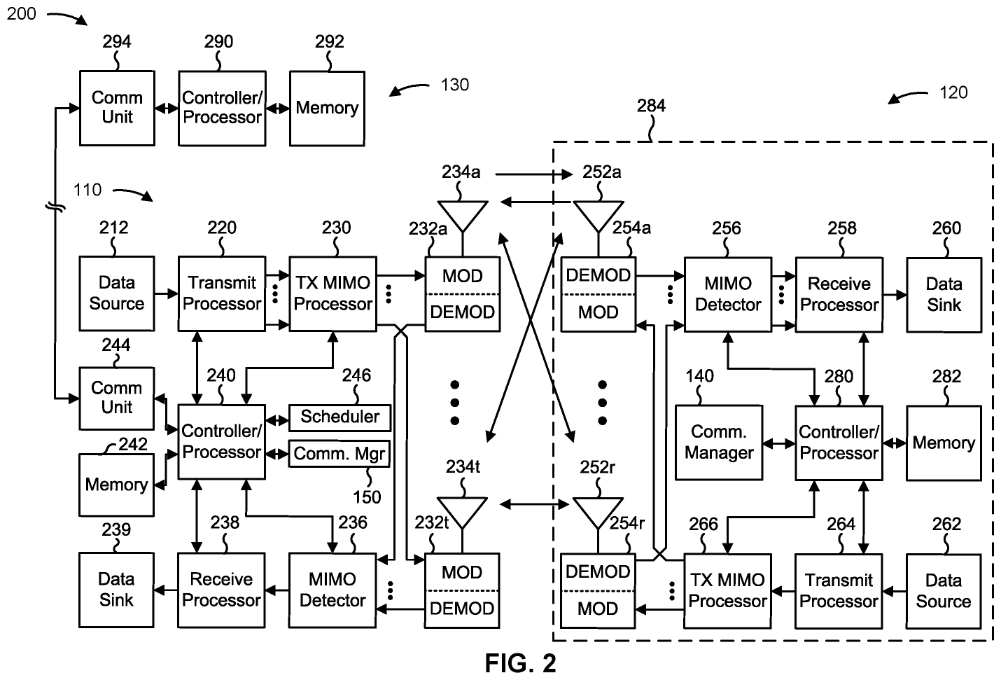

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems). shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

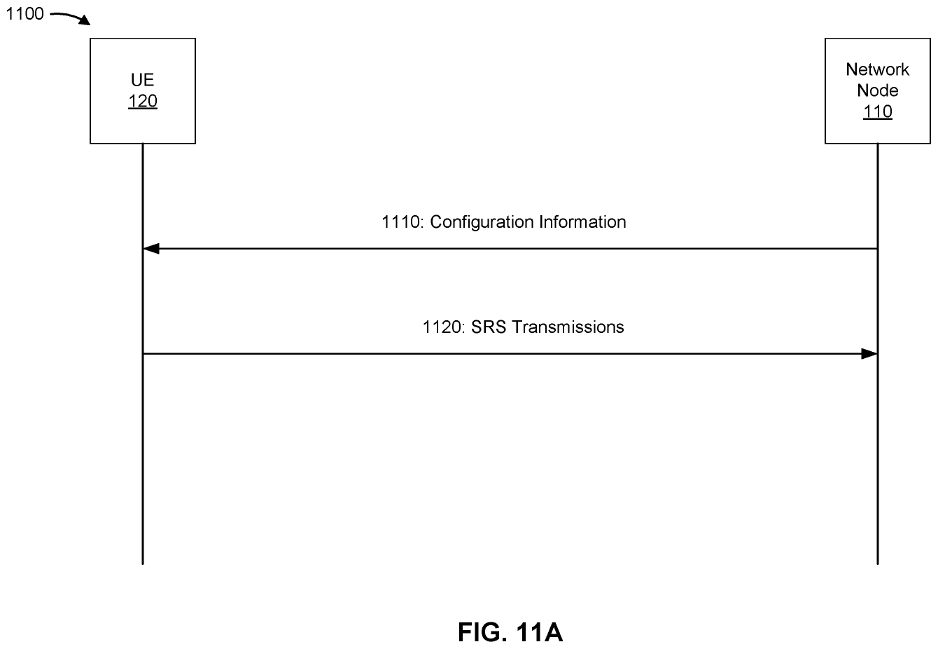

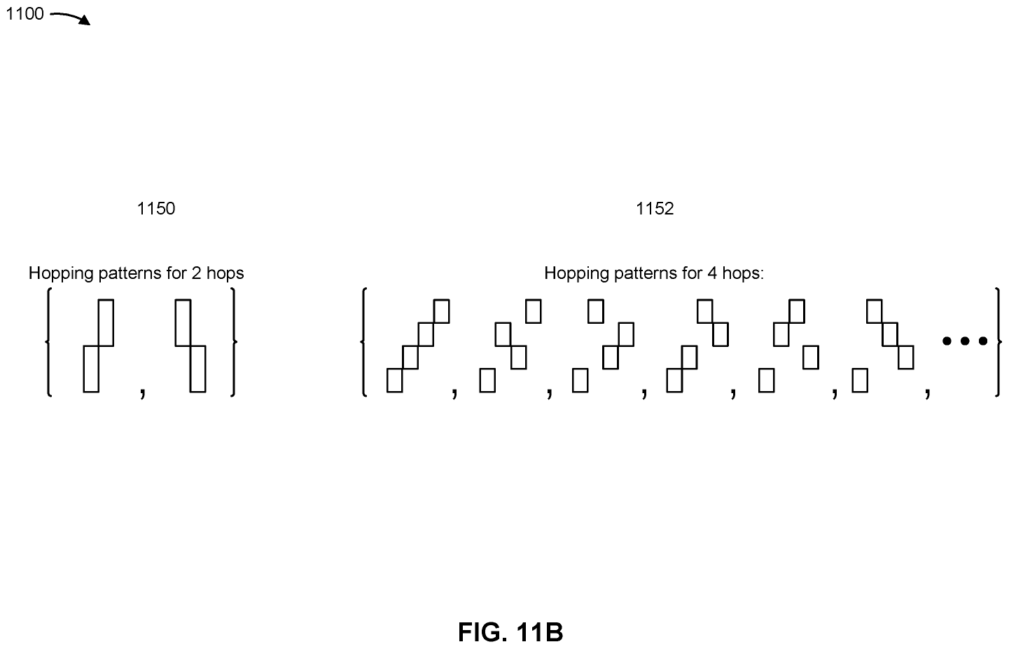

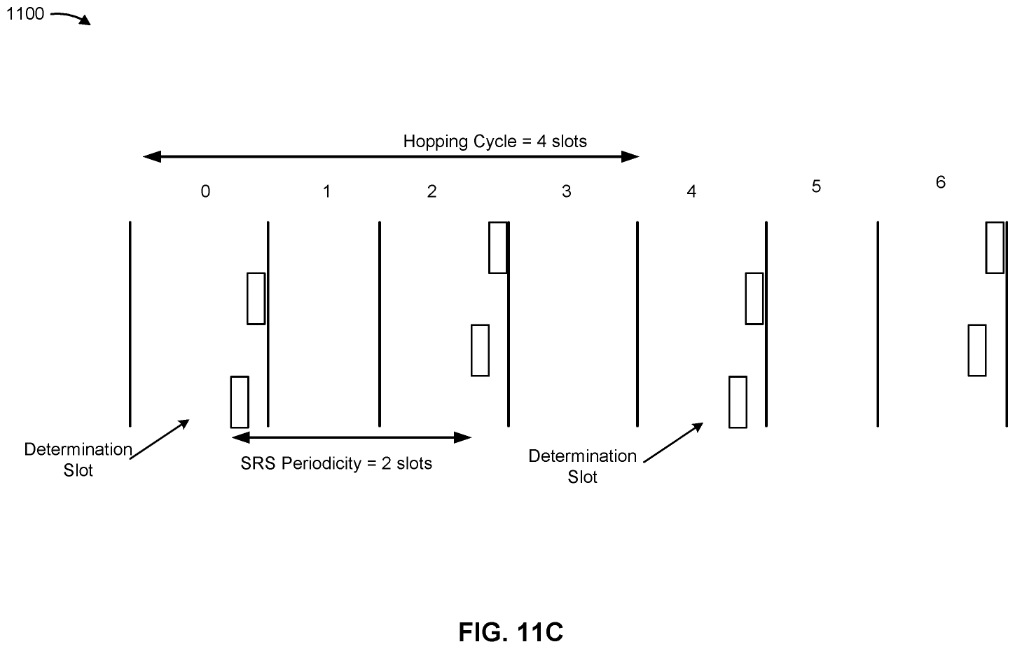

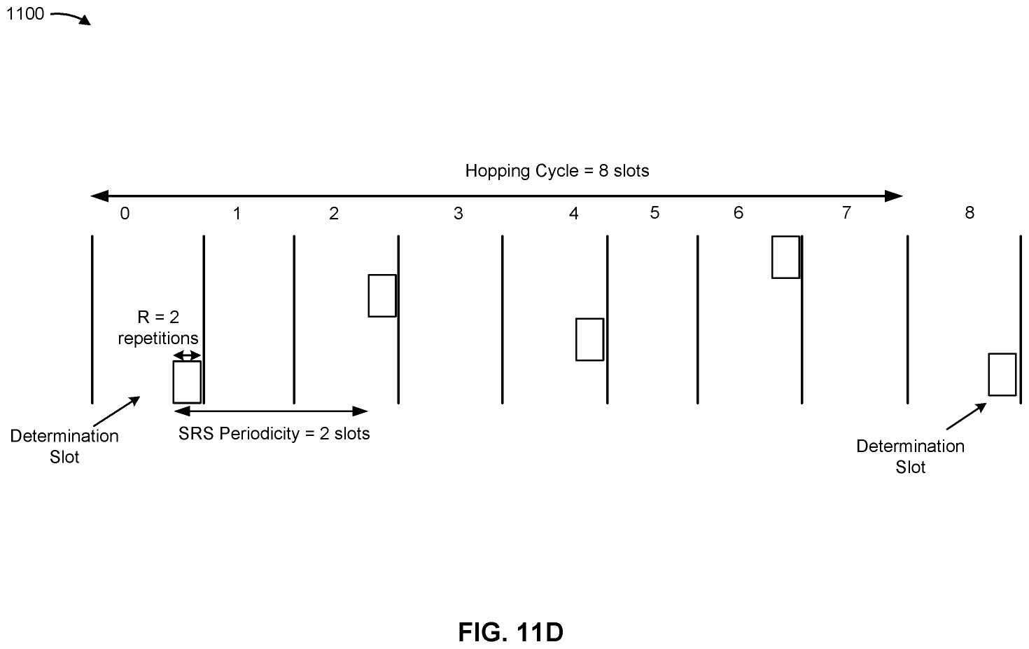

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 11A-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 11A-15).

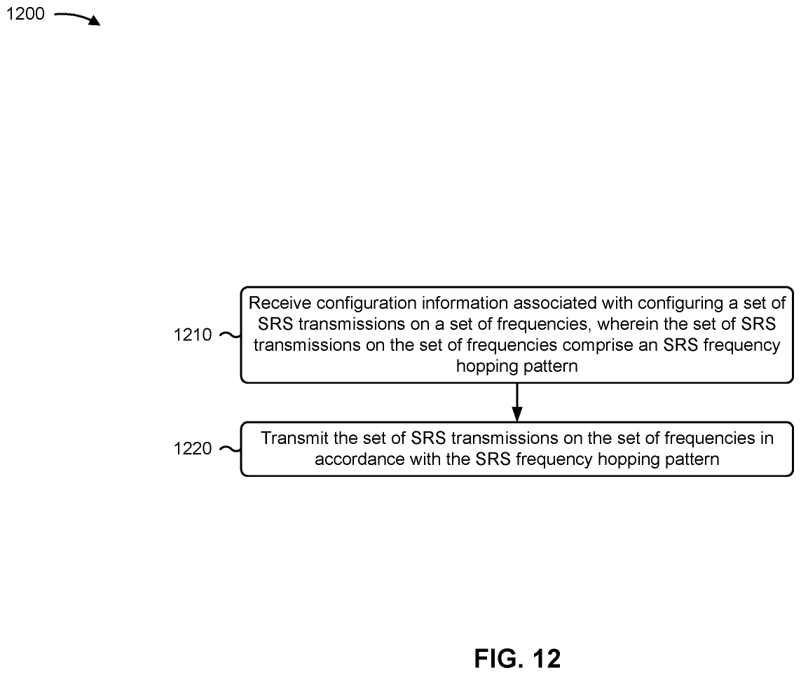

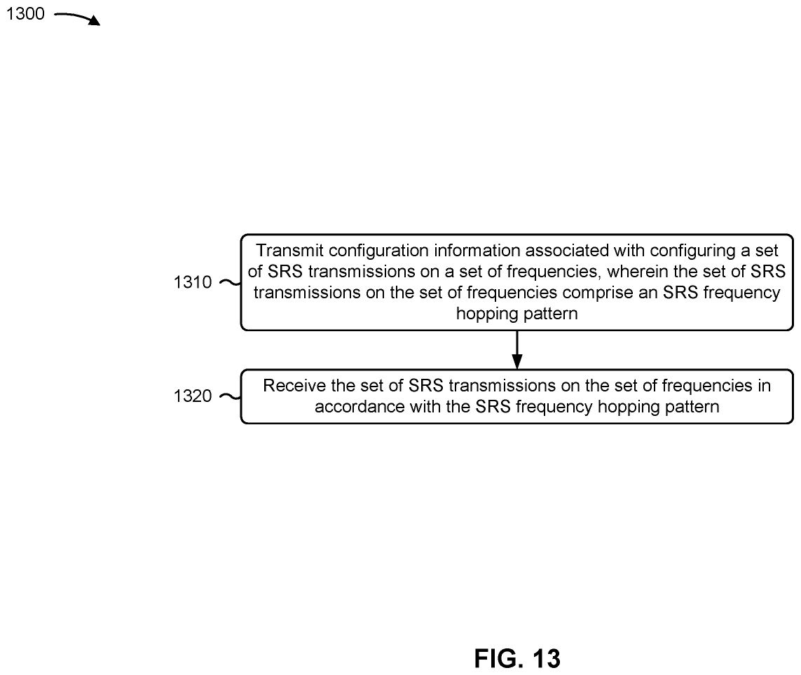

The controller/processor 240 of the network node 110, the controller/processor 280 of the UE 120, and/or any other component(s) of FIG. 2 may perform one or more techniques associated with frequency hopping for SRS transmission, as described in more detail elsewhere herein. For example, the controller/processor 240 of the network node 110, the controller/processor 280 of the UE 120, and/or any other component(s) of FIG. 2 may perform or direct operations of, for example, process 1200 of FIG. 12, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the UE 120 includes means for receiving configuration information associated with configuring a set of SRS transmissions on a set of frequencies, wherein the set of SRS transmissions on the set of frequencies comprise an SRS frequency hopping pattern; and/or means for transmitting the set of SRS transmissions on the set of frequencies in accordance with the SRS frequency hopping pattern. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting configuration information associated with configuring a set of SRS transmissions on a set of frequencies, wherein the set of SRS transmissions on the set of frequencies comprise an SRS frequency hopping pattern; and/or means for receiving the set of SRS transmissions on the set of frequencies in accordance with the SRS frequency hopping pattern. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

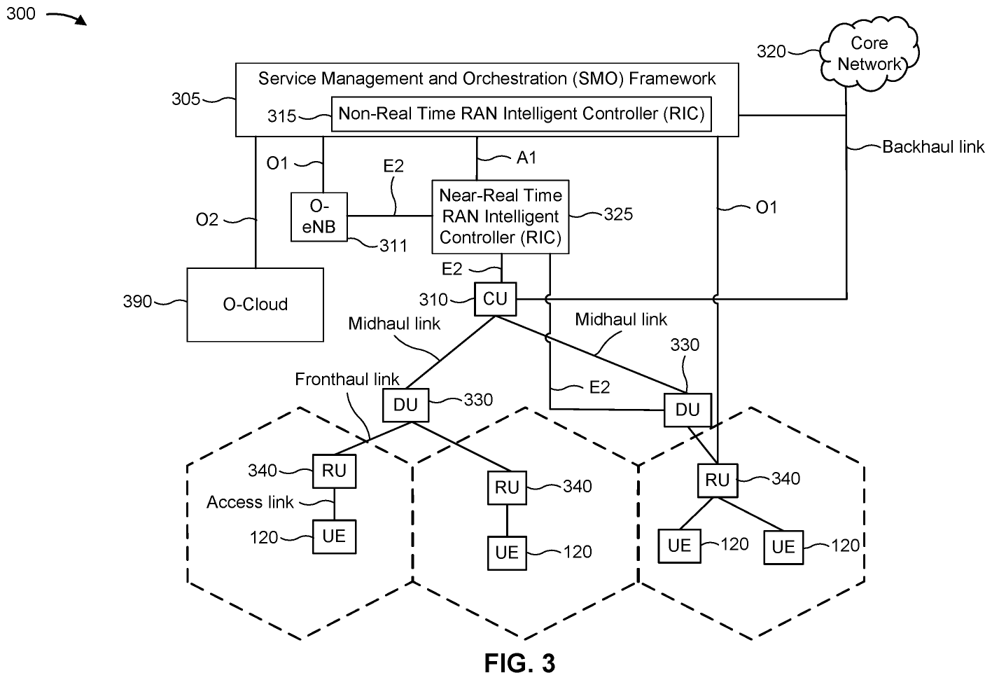

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit. can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example. Central Unit-User Plane (CU-UP) functionality), control plane functionality (for example. Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340. controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to. CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

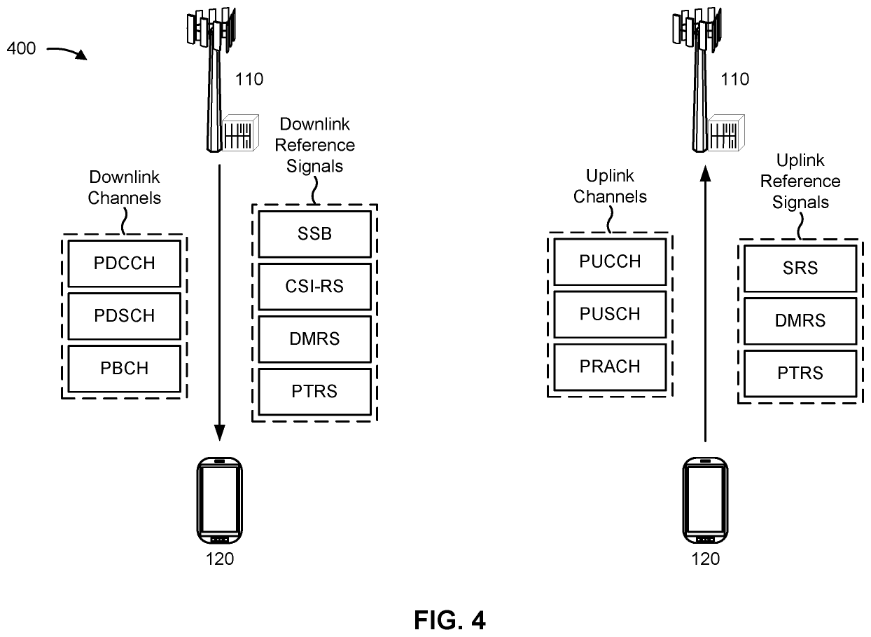

FIG. 4 is a diagram illustrating an example 400 of physical channels and reference signals in a wireless network, in accordance with the present disclosure. As shown in FIG. 4, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some examples. PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a PRACH used for initial network access, among other examples. In some examples, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include an SRS, a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some examples, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a CQI, a precoding matrix indicator (PMI), a CSI-RS resource indicator (CRI), a layer indicator (LI), a rank indicator (RI), or a RSRP, among other examples. The network node 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some examples, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

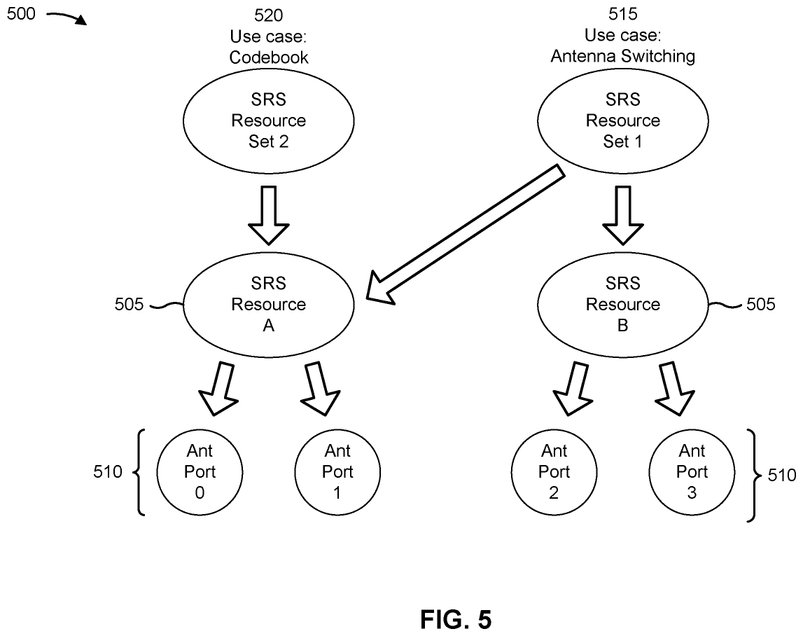

FIG. 5 is a diagram illustrating an example 500 of SRS resource sets, in accordance with the present disclosure.

A UE 120 may be configured with one or more SRS resource sets to allocate resources for SRS transmissions by the UE 120. For example, a configuration for SRS resource sets may be indicated in a RRC message (e.g., an RRC configuration message or an RRC reconfiguration message). As shown by reference number 505, an SRS resource set may include one or more resources (e.g., shown as SRS resources), which may include time resources and/or frequency resources (e.g., a slot, a symbol, a resource block, and/or a periodicity for the time resources).

As shown by reference number 510, an SRS resource may include one or more antenna ports on which an SRS is to be transmitted (e.g., in a time-frequency resource). Thus, a configuration for an SRS resource set may indicate one or more time-frequency resources in which an SRS is to be transmitted and may indicate one or more antenna ports on which the SRS is to be transmitted in those time-frequency resources. In some examples, the configuration for an SRS resource set may indicate a use case (e.g., in an SRS-SetUse information element) for the SRS resource set. For example, an SRS resource set may have a use case of antenna switching, codebook, non-codebook, or beam management.

An antenna switching SRS resource set may be used to indicate downlink CSI with reciprocity between an uplink and downlink channel. For example, when there is reciprocity between an uplink channel and a downlink channel, a network node 110 may use an antenna switching SRS (e.g., an SRS transmitted using a resource of an antenna switching SRS resource set) to acquire downlink CSI (e.g., to determine a downlink precoder to be used to communicate with the UE 120).

A codebook SRS resource set may be used to indicate uplink CSI when a network node 110 indicates an uplink precoder to the UE 120. For example, when the network node 110 is configured to indicate an uplink precoder to the UE 120 (e.g., using a precoder codebook), the network node 110 may use a codebook SRS (e.g., an SRS transmitted using a resource of a codebook SRS resource set) to acquire uplink CSI (e.g., to determine an uplink precoder to be indicated to the UE 120 and used by the UE 120 to communicate with the network node 110). In some examples, virtual ports (e.g., a combination of two or more antenna ports) with a maximum transmit power may be supported at least for a codebook SRS.

A non-codebook SRS resource set may be used to indicate uplink CSI when the UE 120 selects an uplink precoder (e.g., instead of the network node 110 indicated an uplink precoder to be used by the UE 120). For example, when the UE 120 is configured to select an uplink precoder, the network node 110 may use a non-codebook SRS (e.g., an SRS transmitted using a resource of a non-codebook SRS resource set) to acquire uplink CSI. In this case, the non-codebook SRS may be precoded using a precoder selected by the UE 120 (e.g., which may be indicated to the network node 110).

A beam management SRS resource set may be used for indicating CSI for millimeter wave communications.

An SRS resource can be configured as periodic, semi-persistent (sometimes referred to as semi-persistent scheduling (SPS)), or aperiodic. A periodic SRS resource may be configured via a configuration message that indicates a periodicity of the SRS resource (e.g., a slot-level periodicity, where the SRS resources occurs every Y slots) and a slot offset. In some cases, a periodic SRS resource may always be activated, and may not be dynamically activated or deactivated. A semi-persistent SRS resource may also be configured via a configuration message that indicates a periodicity and a slot offset for the semi-persistent SRS resource, and may be dynamically activated and deactivated (e.g., using DCI or a medium access control (MAC) control element (CE) (MAC-CE)). An aperiodic SRS resource may be triggered dynamically, such as via DCI (e.g., UE-specific DCI or group common DCI) or a MAC-CE.

In some examples, the UE 120 may be configured with a mapping between SRS ports (e.g., antenna ports) and corresponding SRS resources. The UE 120 may transmit an SRS on a particular SRS resource using an SRS port indicated in the configuration. In some examples, an SRS resource may span N adjacent symbols within a slot (e.g., where N equals 1, 2, or 4). The UE 120 may be configured with X SRS ports (e.g., where X≤4). In some examples, each of the X SRS ports may mapped to a corresponding symbol of the SRS resource and used for transmission of an SRS in that symbol.

As shown in FIG. 5, in some examples, different SRS resource sets indicated to the UE 120 (e.g., having different use cases) may overlap (e.g., in time and/or in frequency, such as in the same slot). For example, as shown by reference number 515, a first SRS resource set (e.g., shown as SRS Resource Set 1) is shown as having an antenna switching use case. As shown, this example antenna switching SRS resource set includes a first SRS resource (shown as SRS Resource A) and a second SRS resource (shown as SRS Resource B). Thus, antenna switching SRS may be transmitted in SRS Resource A (e.g., a first time-frequency resource) using antenna port 0 and antenna port 1 and may be transmitted in SRS Resource B (e.g., a second time-frequency resource) using antenna port 2 and antenna port 3.

As shown by reference number 520, a second SRS resource set (e.g., shown as SRS Resource Set 2) may be a codebook use case. As shown, this example codebook SRS resource set includes only the first SRS resource (shown as SRS Resource A). Thus, codebook SRSs may be transmitted in SRS Resource A (e.g., the first time-frequency resource) using antenna port 0 and antenna port 1. In this case, the UE 120 may not transmit codebook SRSs in SRS Resource B (e.g., the second time-frequency resource) using antenna port 2 and antenna port 3.

As indicated above, FIG. 5 is provided as an example. Other examples may differ from what is described with regard to FIG. 5.

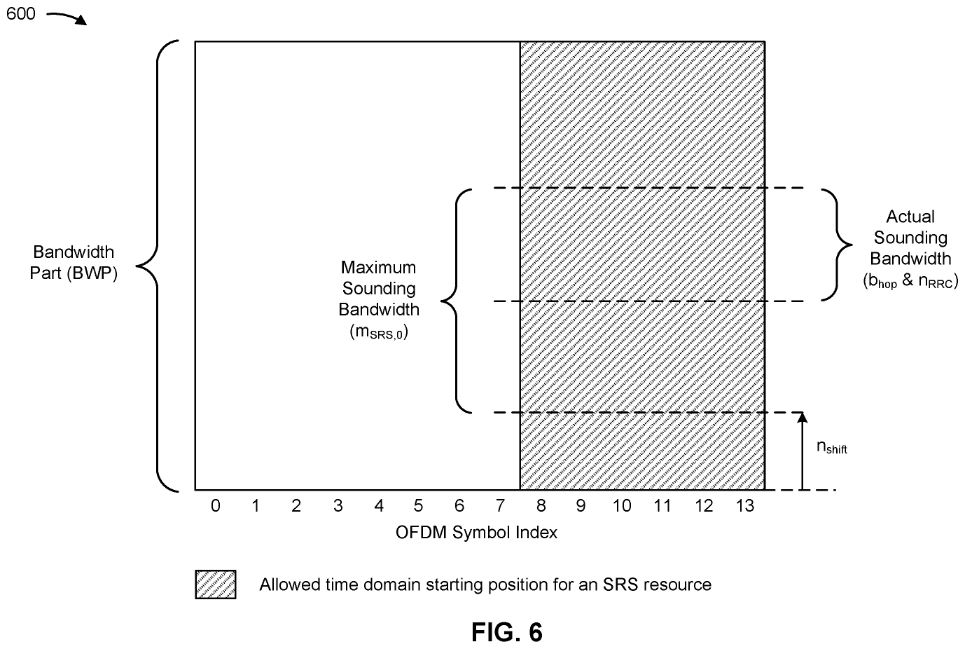

FIG. 6 is a diagram illustrating an example 600 of an SRS bandwidth configuration, in accordance with the present disclosure.

As shown in FIG. 6, starting positions, within a time domain, for an SRS resource may span a bandwidth part (BWP) and a set of orthogonal frequency division multiplexed (OFDM) symbol indices. A UE may be configured with a maximum sounding bandwidth (m_{SRS,0}) that is less than the whole bandwidth part. An offset between a boundary of the bandwidth part (e.g., a lower boundary) may be referred to as a shift value n_{shift}. The shift value corresponds to an index of a first physical resource block (PRB) of the maximum sounding bandwidth. Within the maximum sounding bandwidth, the UE may be configured with an actual sounding bandwidth (e.g., that is less than or equal to the maximum sounding bandwidth). The actual sounding bandwidth may be associated with a set of parameters, such as bₕₒₚ, which is a frequency hopping bandwidth of an SRS that is to be transmitted by the UE, and n_{RRC}, which is a frequency domain position of the SRS. The first parameter, bₕₒₚ, can be configured as an integer value (e.g., 0-3), which corresponds to an actual sounding bandwidth m_{SRS,b}, where b=bₕₒₚ. Similarly, the second parameter n_{RRC}, can be configured as an integer value (e.g., 0-67), which corresponds to a position of the actual sounding bandwidth within the maximum sounding bandwidth. A third parameter, B_{SRS}, can be configured as an integer value (e.g., 0-3), which corresponds to a quantity of PRBs within the actual sounding bandwidth that are sounded in each hop of a frequency hopping cycle. Frequency hopping may be enabled, for the UE, based at least in part on a relationship of the second parameter and the third parameter, such as when bₕₒₚ<B_{SRS}. Additional details regarding frequency hopping for SRS transmission may be described with regard to 3GPP Technical Specification (TS) 38.211.

As indicated above, FIG. 6 is provided as an example. Other examples may differ from what is described with respect to FIG. 6.

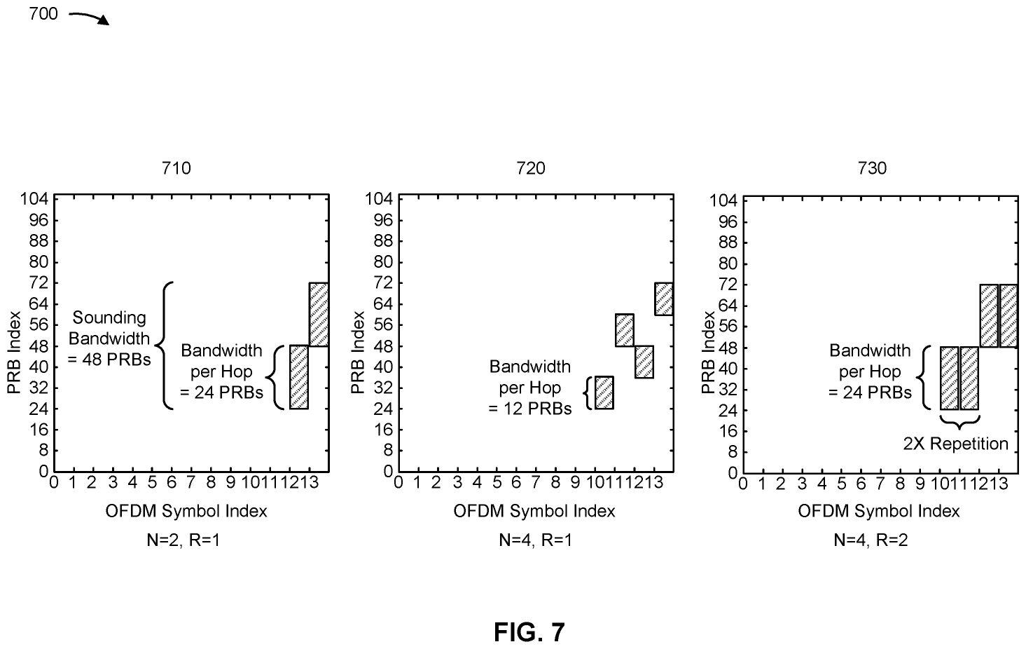

FIG. 7 is a diagram illustrating an example 700 of frequency hopping and repetition, in accordance with the present disclosure.

As shown in FIG. 7, different SRS resources can be configured with different parameters for frequency hopping and/or repetition. For example, each SRS resource can be configured with a quantity, N, of OFDM symbols for SRS resource transmission and a quantity, R, of repetitions of an SRS signal. When R<N, there may be N/R frequency hops within an SRS resource. Diagram 710 of a first SRS resource shows an example of an SRS resource configuration with N=2, R=1. As shown, a sounding bandwidth is 48 PRBs and a bandwidth per hop is 24 PRBs (with no repetitions). Diagram 720 of a second SRS resource shows an example of an SRS resource configuration with N=4, R=1. As shown, the sounding bandwidth is 48 PRBs and the bandwidth per hop is 12 PRBs (with no repetitions). Diagram 730 of a third SRS resource shows an example of an SRS resource configuration with N=4, R=2. As shown, the sounding bandwidth is 48 PRBs, and the bandwidth per hop is 24 PRBs (with 2 repetitions of each SRS transmission). Although some values for the quantity of OFDM symbols per SRS resource and the repetition factor are described, it should be understood that other values are contemplated. Further, it should be understood that a “repetition” may refer to both an original communication and a subsequent transmission of the original communication. In other words, when there are 2 repetitions of a signal, the signal may be transmitted twice, and each transmission of the signal may be referred to as a “repetition” of the signal. Accordingly, as described above, when R=2 (e.g., two repetitions), an SRS transmission is transmitted twice and each of the two SRS transmissions is a repetition of the SRS transmission.

As indicated above, FIG. 7 is provided as an example. Other examples may differ from what is described with respect to FIG. 7.

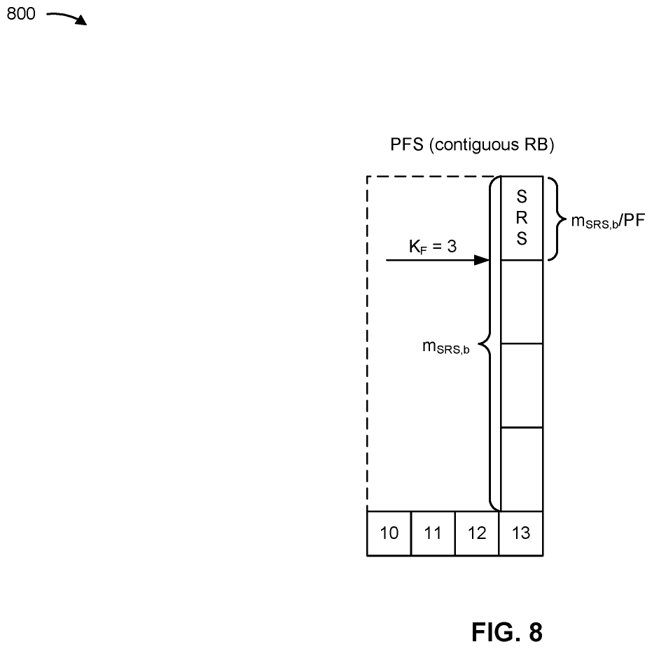

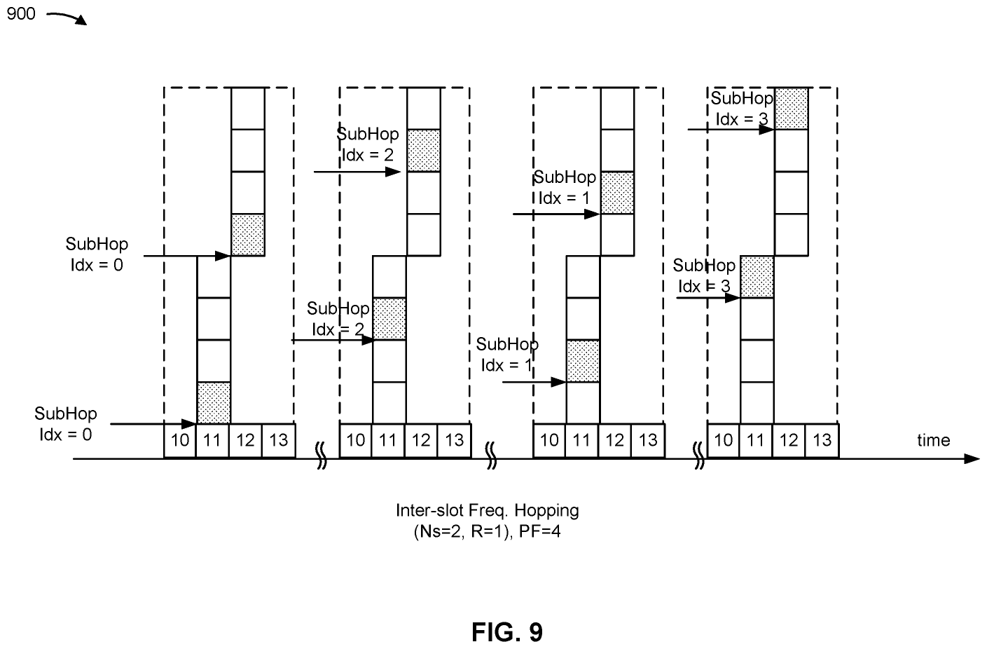

FIGS. 8 and 9 are diagrams illustrating examples 800/900 of SRS partial frequency sounding, in accordance with the present disclosure.

As shown in FIG. 8, and by example 800, a UE may be configured to sound a subset of contiguous resource blocks (RBs). For example, the UE may be configured with a first parameter, P_{F}, which is a partial frequency allocation of an SRS RB, and a second parameter K_{F}, which is a starting RB within a set of SRS RBs (m_{SRS,B_SRS}) with K_{F} being in a range of 0 to P_{F}−1 and a starting RB index being based at least in part

$$\frac{{m}_{SRS , {B}_{SRS}}}{P F} \times {K}_{F} .$$

Similarly, a length of an SRS Zadoff-Chu (ZC) sequence is based at least in part on partial RBs

$${M}_{sc , b}^{SRS} = \frac{12}{{K}_{T C} \times {P}_{F}} {m}_{SRS , {B}_{S R S}} .$$

By allowing contiguous RB partial frequency sounding (RPFS), a network node and a UE improve SRS capacity and enabling multiplexing of more SRS ports. For example, when the UE sounds on a subset of contiguous RBs, other UEs can use other RBs in the contiguous RBs. In addition to improving SRS capacity, the network node and the UE improve SRS coverage, such as for cell edge UEs, by enabling per-tone power boosting relative to full frequency sounding.

As shown in FIG. 9, and by example 900, a UE may be configured for partial frequency sounding with starting resource block hopping. For example, when frequency hopping is enabled for SRS, a starting RB for SRS partial frequency sounding can be changed over a set of frequency hopping periods. This may enable a UE to sound different RBs across frequency hopping periods. The UE may be configured with a parameter k_{hopping} at an SRS resource level to enable determination or specification of a starting resource block index N_{offset} at each frequency hopping period, where

$${N}_{offset} = \frac{( {k}_{F} + {k}_{hopping} ) mod {P}_{F}}{{P}_{F}} {m}_{SRS , {B}_{SRS}} .$$

In this case, k_{hopping} may be constant across a set of SRS occasions within a frequency hopping period, but may change between different frequency hopping periods. The parameter k_{hopping} may be set to a particular value (e.g., 0) for SRS symbols in which start resource block hopping is disabled. Different partial frequency hopping schemes may be configured using a bit-reversal technique such that, for example, for PF (a quantity of hops)=2, k_{hopping}={0, 1} and for PF=4, k_{hopping}={0, 2, 1, 3}.

As indicated above, FIGS. 8 and 9 are provided as examples. Other examples may differ from what is described with respect to FIGS. 8 and 9.

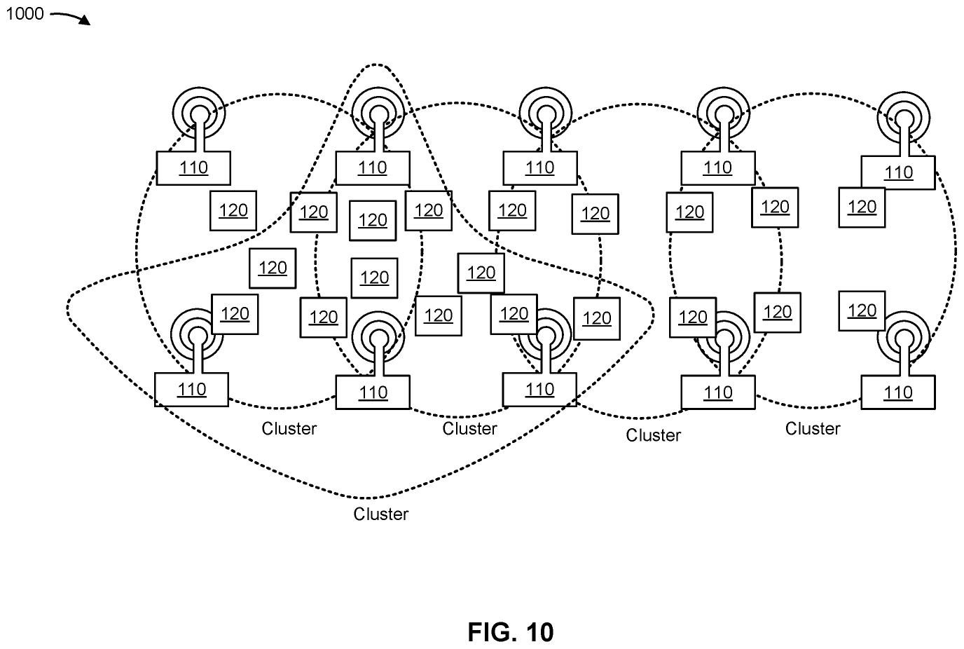

FIG. 10 is a diagram illustrating an example 1000 of coherent joint transmission operation, in accordance with the present disclosure.

As shown in FIG. 10, in coherent joint transmission operation, a plurality of network nodes 110 (e.g., TRPs) may have overlapping coverage areas for a plurality of UEs 120. For example, example 1000 shows a cluster size of 4 and 4 UEs 120 in each cluster for coherent joint transmission (CJT) communications. In CJT communications, multiple network nodes 110 may need to receive SRS transmissions from a particular UE 120. Accordingly, for large quantities of UEs 120, a plurality of UEs 120 may be configured to send SRS transmissions on the same OFDM symbols. Interference randomization techniques may be applied to account for inter-cluster interference. For example, the UEs 120 and the network nodes 110 may perform group hopping and sequence hopping in an SRS base sequence domain to account for interference.

Multiple base sequences r̅_{u,v}(n) may be possible to support sequence hopping. For example, some communications systems may have a plurality of sequences for a particular length, and the plurality of sequences may be grouped into a set of groups with one or more sequences in each group. For example, for sequences of length longer than 72 elements, a group may include 2 sequences, and for sequences of a length not longer than 72 elements, a group may include a single sequence. Different base sequences may have relatively low cross-correlation (though may not be completely orthogonal), resulting in a relatively low level of interference between SRSs with different base sequences. Additional details regarding base sequences may be described with regard to 3GPP TS XXX.XX.

Accordingly, although using different base sequences in sequence hopping may reduce interference, further interference randomization may be useful to ensure that SRS transmissions are correctly received by the network nodes. A failure to correctly receive SRS transmissions may result in poor communication performance, dropped communications, and/or interference to subsequent communications.

As indicated above, FIG. 10 is provided as an example. Other examples may differ from what is described with respect to FIG. 10.

Some aspects described herein enable interference reduction by using randomized frequency hopping. For example, a UE may be configured with a random hopping scheme for SRS frequency hopping, which may enable interference randomization (e.g., with or without sequence hopping, group hopping, cyclic shift hopping, or other interference randomization techniques). In this way, the UE and a network node may reduce a likelihood of interference to SRS transmissions, thereby improving communication performance, reducing dropped communications, and/or reducing interference to subsequent communications.

FIGS. 11A-11D are diagrams illustrating an example 1100 associated with frequency hopping for sounding reference signal transmission, in accordance with the present disclosure. As shown in FIG. 11A, example 1100 includes communication between a network node 110 and a UE 120.

As further shown in FIG. 11A, and by reference number 1110, the UE 120 may receive configuration information from the network node 110. For example, the UE 120 may receive configuration information associated with configuring a set of SRS transmissions on a set of frequencies. In some aspects, the UE 120 may receive configuration information associated with identifying an SRS frequency hopping pattern. For example, the UE 120 may receive configuration information identifying the set of frequencies and a set of time resources on which to transmit the set of SRS transmissions, and the set of frequencies and the set of time resources may form an SRS frequency hopping pattern. In other words, an SRS frequency hopping pattern may be associated with a set of frequencies and a set of time resources for transmission of a set of SRS transmissions.

In some aspects, the UE 120 may receive an RRC message conveying the configuration information. For example, the UE 120 may receive an RRC message that is associated with enabling or disabling use of an SRS frequency hopping pattern for an SRS resource. In this case, the RRC message may include information identifying the SRS frequency hopping pattern that is to be enabled or disabled for the SRS resource. Additionally, or alternatively, the UE 120 may receive an RRC message associated with enabling or disabling use of one or more SRS frequency hopping patterns for an SRS resource set.

In some aspects, the UE 120 may receive configuration information selecting an SRS frequency hopping pattern. For example, the UE 120 may be configured with or may receive configuration information identifying a plurality of possible SRS frequency hopping patterns. In this case, the UE 120 may receive configuration information associated with selecting one or more of the plurality of possible SRS frequency hopping patterns. For example, the UE 120 may receive configuration information identifying an index value that corresponds to an SRS frequency hopping pattern.

In some aspects, the UE 120 may receive configuration information indicating that the UE 120 is to use a particular set of hops as a frequency hopping pattern. For example, as shown in FIG. 11B, a hopping pattern for 2 hops may include a first hop H1 and a second hop H2. Similarly, a hopping pattern for 4 hops may include H1, H2, a third hop H3, and a fourth hop H4. In some aspects, the set of patterns of the possible hops may be fixed. For example, for a 2 hop cycle, the UE 120 may be statically configured with 2!=2 hopping patterns {(H1, H2), (H2, H1)}, as shown by diagram 1150. Similarly, for a 4 hop cycle, the UE 120 may be statically configured with 4!=24 hopping patterns {(H1, H2, H3, H4), (H1, H3, H2, H4), (H1, H4, H2, H3), (H1, H2, H4, H3), (H1, H3, H4, H2), (H1, H4, H3, H2), . . . }, as shown by diagram 1152. Additionally, or alternatively, the set of patterns of the possible hops may be dynamically configured. For example, the UE 120 may receive RRC configuration identifying {(H1, H2, H3, H4), (H1, H3, H2, H4)} as the set of possible SRS frequency hopping patterns for a 4 hop cycle. This may reduce implementation complexity by constraining a quantity of possible SRS frequency hopping configurations and/or may reduce signaling overhead by reducing a quantity of indices that are possible to cover the set of possible SRS frequency hopping configurations. In some aspects, the UE 120 may randomly or pseudo-randomly select hops from a set of hops for an SRS frequency hopping pattern. For example, the UE 120 may randomly select a hop from a set of hops {H1, H2, H3, H4} for an SRS transmission.

In some aspects, the UE 120 may determine the SRS frequency hopping pattern based at least in part on a random or pseudo-random SRS frequency hopping scheme. For example. the UE 120 may determine an SRS frequency hopping pattern based at least in part on an initialization value and a time value. In this case, the UE 120 may determine the SRS frequency hopping pattern based at least in part on a slot number within a radio frame and a first symbol of an SRS resource. Accordingly, in this case, the configuration information may be information identifying the slot number and/or the first symbol of the SRS resource. The UE 120 may determine an SRS frequency hopping pattern index as:

$${f}_{fh , pattern} ( {n}_{s , f}^{μ} ) = ( {\sum }_{m = 0}^{M - 1} c ( M \cdot ( {n}_{s , f}^{μ} {N}_{symb}^{slot} + {l}_{0} ) + m ) \cdot {2}^{m} ) mod H$$

where f_{fh}, pattern (n_{s,f}^{μ}) is the SRS frequency hopping pattern index c is a pseudo-random sequence, n_{s,f}^{μ} is a slot number of a slot within a frame, and l₀ is a first symbol of an SRS resource within the slot. Additionally, or alternatively, the UE 120 may determine the SRS frequency hopping pattern index based at least in part on an initialization value (e.g., the slot number) and not a time value (e.g., the first symbol of the SRS resource):

$${f}_{fh , pattern} ( {n}_{s , f}^{μ} ) = ( {\sum }_{m = 0}^{M - 1} c ( M \cdot {n}_{s , f}^{μ} + m ) \cdot {2}^{m} ) mod H$$

where the parameter l₀ is omitted to make the SRS frequency hopping pattern index independent of the first symbol of an SRS resource within the slot.

In some aspects, the UE 120 may determine an SRS frequency hopping pattern based at least in part on a type of SRS transmission. For example, the UE 120 may determine an intra-slot SRS frequency hopping pattern for aperiodic SRS transmission. Additionally, or alternatively, the UE 120 may determine an intra-slot or inter-slot SRS frequency hopping pattern for periodic or semi-persistent SRS transmission. In this case, a frequency hopping cycle can span across a plurality of SRS periodicities, such that a frequency hopping cycle of S slots with a periodicity of an SRS resource of P slots results in a quantity H=S/P, where H is a quantity of hops in each period. For example, with a configured periodicity of 2 slots and each hopping cycle spanning 2 periodicities, the frequency hopping cycle is S=2×2=4 slots. The UE 120 may determine a span of an SRS frequency hopping cycle with R repetitions as R*S slots, determined based at least in part on a first slot in a group of S slots or a first slot of a hopping cycle and/or a first symbol of an SRS resource.

FIG. 11C shows an example of periodic or semi-persistent SRS transmission with a periodicity of 2 slots and a hopping cycle of 4 slots. As shown, the UE 120 determines the span of the SRS frequency hopping cycle (e.g., slots 0 to 3) in a first slot in which an SRS transmission occurs (e.g., slot 0). In this case, the SRS periodicity is 2 slots (e.g., resulting in transmission in slots 0 and 2), and the UE 120 re-determines the span of the SRS frequency hopping cycle (e.g., slots 4 to 7), resulting in another 2 slot SRS periodicity (e.g., transmission in slots 4 and 6). FIG. 11D shows another example of periodic or semi-persistent SRS transmission with a periodicity of 2 slots, a repetition factor of 2, and an SRS frequency hopping cycle of 8 slots. As shown, the UE 120 determines the span of the SRS frequency hopping cycle (e.g., slots 0 to 7) in a first slot in which an SRS transmission occurs (e.g., slot 0), resulting in an SRS periodicity of 2 slots (e.g., transmission in slots 0, 2, 4, and 6). In some aspects, the UE 120 determination of the span of the SRS frequency hopping cycle (which is performed once each S slots) can be a function of the first slot in a group of S slots or the first slot as well as the first symbol of the SRS resource, among other examples.

In some aspects, the UE 120 may receive configuration information associated with SRS partial frequency sounding and frequency hopping. For example, the UE 120 may receive RRC configuration information (e.g., a random hopping scheme enabling or disabling message) identifying with a random hopping scheme for a starting resource block for SRS partial frequency sounding (e.g., on a per SRS resource or per SRS resource set basis). In this case, the parameter k_{hopping} for a starting resource block may be based at least in part on a pseudo-random sequence, an initialization value, or a time value, among other examples. For example, the UE 120 may determine the SRS frequency hopping pattern based at least in part on a slot number of a slot within a radio frame, a symbol number within the slot, and a hop index according to an equation:

$${f}_{pfh , khopping} ( {n}_{s , f}^{μ} , {l}^{′} ) = ( {\sum }_{m = 0}^{M - 1} c ( M \cdot ( {n}_{s , f}^{μ} {N}_{symb}^{slot} + {l}_{0} + {l}^{′} + h ) + m ) \cdot {2}^{m} ) mod {P}_{F}$$

where c represents a pseudo-random sequence, n_{s,f}^{μ} represents a slot number within a frame, l₀+l′ represents a symbol number (e.g., l₀ is a first symbol of an SRS resource within the slot and l′ is a symbol number within the SRS resource), and h represents a hop index. In this case, different hops within the same SRS frequency hopping cycle have different starting resource blocks based at least in part on the pseudo-random sequence. Additionally, or alternatively, the UE 120 may determine the SRS frequency hopping pattern based at least in part on a slot number within a radio frame and a symbol number within a slot (and not a hop index):

$${f}_{pfh , khopping} ( {n}_{s , f}^{μ} , {l}^{′} ) = ( {\sum }_{m = 0}^{M - 1} c ( M \cdot ( {n}_{s , f}^{μ} {N}_{symb}^{slot} + {l}_{0} + {l}^{′} ) + m ) \cdot {2}^{m} ) mod {P}_{F}$$

where the hop index term h is removed and where different symbols within the same slot have different starting resource blocks based at least in part on the pseudo-random sequence. Additionally, or alternatively, the UE 120 may determine the SRS frequency hopping pattern based at least in part on a slot number within a radio frame (and not a symbol number within a slot or a hop index):

$${f}_{pfh , khopping} ( {n}_{s , f}^{μ} ) = ( {\sum }_{m = 0}^{M - 1} c ( M \cdot {n}_{s , f}^{μ} + m ) \cdot {2}^{m} ) mod {P}_{F}$$

where, in a particular slot, a starting resource block does not change for an SRS resource (but different SRS resources in different slots can have different starting resource blocks). Additionally, or alternatively, the UE 120 may determine the SRS frequency hopping pattern based at least in part on a slot number of a slot within a radio frame and a first symbol of an SRS resource:

$${f}_{pfh , khopping} ( {n}_{s , f}^{μ} ) = ( {\sum }_{m = 0}^{M - 1} c ( M \cdot ( {n}_{s , f}^{μ} {N}_{symb}^{slot} + {l}_{0} ) + m ) \cdot {2}^{m} ) mod {P}_{F}$$

where the SRS frequency hopping pattern is based at least in part on a symbol of an SRS resource within a slot.

In some aspects, the UE 120 may determine an initialization value for the pseudo-random sequence c. For example, the UE 120 may initialize the pseudo-random sequence at a beginning of each radio frame. In some aspects, the UE 120 may initialize the pseudo-random sequence based at least in part on an SRS sequence identity, such that cᵢₙᵢₜ=n_{ID}^{SRS}, where n_{ID}^{SRS} is the SRS sequence identity configured for an SRS resource in which the pseudo-random sequence is being used. Additionally, or alternatively, the UE 120 may initialize the pseudo-random sequence based at least in part on a parameter of the configuration information (e.g., an RRC parameter identifying an initialization value). Additionally, or alternatively, the UE 120 may initialize the pseudo-random sequence based at least in part on an SRS frequency hopping pattern:

cᵢₙᵢₜ=n_{ID}^{SRS}*Hₘₐₓ+H; or

cᵢₙᵢₜ=H*n_{ID,max}^{SRS}+n_{ID}^{SRS}

where Hₘₐₓ is a maximum quantity of frequency hopping patterns configurable for the UE 120, H is a quantity of configured frequency hopping patterns for the UE 120, and n_{ID,max}^{SRS} is a maximum quantity of SRS sequence identities. Additionally, or alternatively, the UE 120 may initialize the pseudo-random sequence based at least in part on a partial frequency sounding allocation:

cᵢₙᵢₜ=n_{ID}^{SRS}*P_{F}+K_{F}; or

cᵢₙᵢₜ=K_{F}*P_{F}*n_{ID,max}^{SRS}+n_{ID}^{SRS}

where K_{F} represents a starting resource block within a partial frequency sounding and P_{F} represents a partial frequency allocation of SRS resource blocks. In this case, SRS resources across a plurality of UEs 120 in a network may hop deterministically to ensure orthogonality (e.g., by maintaining a different quantity of partial frequency sounding allocations or a different starting resource block). In some aspects, each UE 120 may have the same SRS sequence identity, quantity of partial frequency sounding allocations, and/or starting resource block. In this case, use of a pseudo-random sequence maintains interference randomization if any UEs 120 have different SRS sequence identities, quantities of partial frequency sounding allocations, and/or starting resource blocks

As further shown in FIG. 11A, and by reference number 1120, the UE 120 may transmit a set of SRS transmissions. For example, the UE 120 may transmit the set of SRS transmissions on a set of frequencies in accordance with the SRS frequency hopping pattern. In this case, the network node 110 may receive the set of SRS transmissions on the set of frequencies and/or other SRS transmissions from other UEs 120 and may use the interference randomization and/or one or more interference cancellation techniques to successfully process the set of SRS transmissions and/or the other SRS transmissions.

As indicated above, FIGS. 11A-11D is provided as an example. Other examples may differ from what is described with respect to FIG. 11A-11D.

FIG. 12 is a diagram illustrating an example process 1200 performed, for example, by a UE, in accordance with the present disclosure. Example process 1200 is an example where the UE (e.g., UE 120) performs operations associated with frequency hopping for SRS transmission.

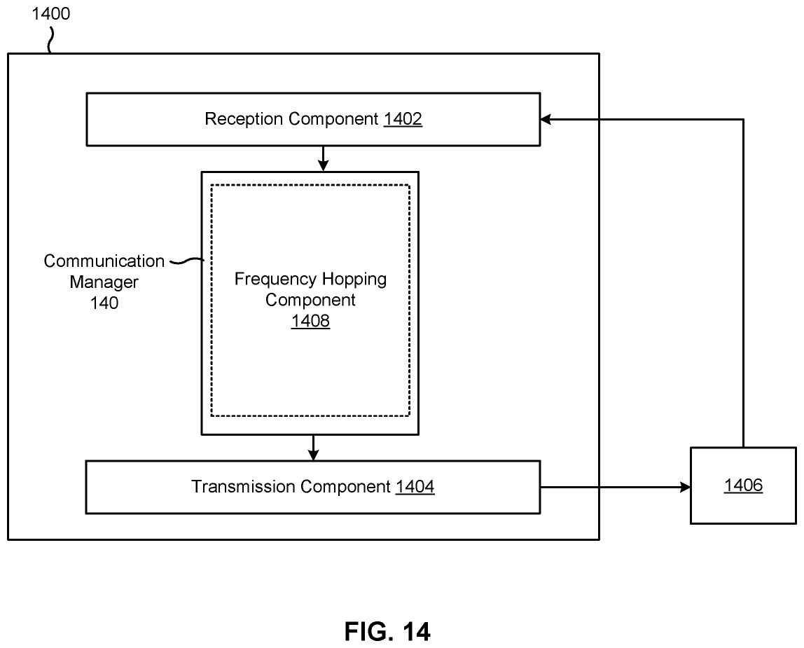

As shown in FIG. 12, in some aspects, process 1200 may include receiving configuration information associated with configuring a set of SRS transmissions on a set of frequencies, wherein the set of SRS transmissions on the set of frequencies comprise an SRS frequency hopping pattern (block 1210). For example, the UE (e.g., using antenna 252, DEMOD 254, MIMO detector 256, receive processor 258, controller/processor 280, communication manager 140, and/or reception component 1402 depicted in FIG. 14) may receive configuration information associated with configuring a set of SRS transmissions on a set of frequencies, wherein the set of SRS transmissions on the set of frequencies comprise an SRS frequency hopping pattern, as described above.

As further shown in FIG. 12, in some aspects, process 1200 may include transmitting the set of SRS transmissions on the set of frequencies in accordance with the SRS frequency hopping pattern (block 1220). For example, the UE (e.g., using controller/processor 280, transmit processor 264, TX MIMO processor 266, MOD 254, antenna 252, communication manager 140, and/or transmission component 1404 depicted in FIG. 14) may transmit the set of SRS transmissions on the set of frequencies in accordance with the SRS frequency hopping pattern, as described above.

Process 1200 may include additional aspects, such as any single aspect or any combination of aspects described below and/or in connection with one or more other processes described elsewhere herein.

In a first aspect, the SRS frequency hopping pattern is a random hopping scheme.

In a second aspect, alone or in combination with the first aspect, receiving the configuration information comprises receiving the configuration information via radio resource control signaling that enables or disables the SRS frequency hopping pattern on a per SRS resource or per SRS resource set basis.

In a third aspect, alone or in combination with one or more of the first and second aspects, the SRS frequency hopping pattern is indicated, by the configuration information, from a set of possible SRS frequency hopping patterns configured for the UE.

In a fourth aspect, alone or in combination with one or more of the first through third aspects, the SRS frequency hopping pattern is a set of statically configured SRS frequency hopping patterns or a set of dynamically configured SRS frequency hopping patterns.

In a fifth aspect, alone or in combination with one or more of the first through fourth aspects, the SRS frequency hopping pattern is based at least in part on at least one of a pseudo-random sequence, an initialization value, a time value, a slot number within a radio frame, or a symbol index of an SRS resource.

In a sixth aspect, alone or in combination with one or more of the first through fifth aspects, the SRS frequency hopping pattern spans a plurality of SRS periodicities.

In a seventh aspect, alone or in combination with one or more of the first through sixth aspects, the SRS frequency hopping pattern includes a set of possible hops, and wherein a transmission, of the set of SRS transmissions, is transmitted on a frequency, of the set of frequencies, based at least in part on a hop selected from the set of possible hops.

In an eighth aspect, alone or in combination with one or more of the first through seventh aspects, the SRS frequency hopping pattern is associated with an SRS partial frequency sounding and frequency hopping mode of the UE.

In a ninth aspect, alone or in combination with one or more of the first through eighth aspects, a starting resource block for the SRS frequency hopping pattern is based at least in part on at least one of a pseudo-random sequence, an initialization value, a time value, a slot number within a radio frame, or a symbol index of an SRS resource.

In a tenth aspect, alone or in combination with one or more of the first through ninth aspects, an initialization for a pseudo-random sequence associated with the SRS frequency hopping patterns is based at least in part on at least one of an SRS sequence identity, a radio resource control initialization parameter, a parameter associated with a maximum quantity of configured SRS frequency hopping patterns, a parameter associated with a configured quantity of frequency hopping patterns, a parameter associated with a maximum quantity of configured SRS sequence identities, a partial frequency sounding allocation parameter, or a starting resource block for partial frequency sounding.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., network node 110) performs operations associated with frequency hopping for SRS transmission.

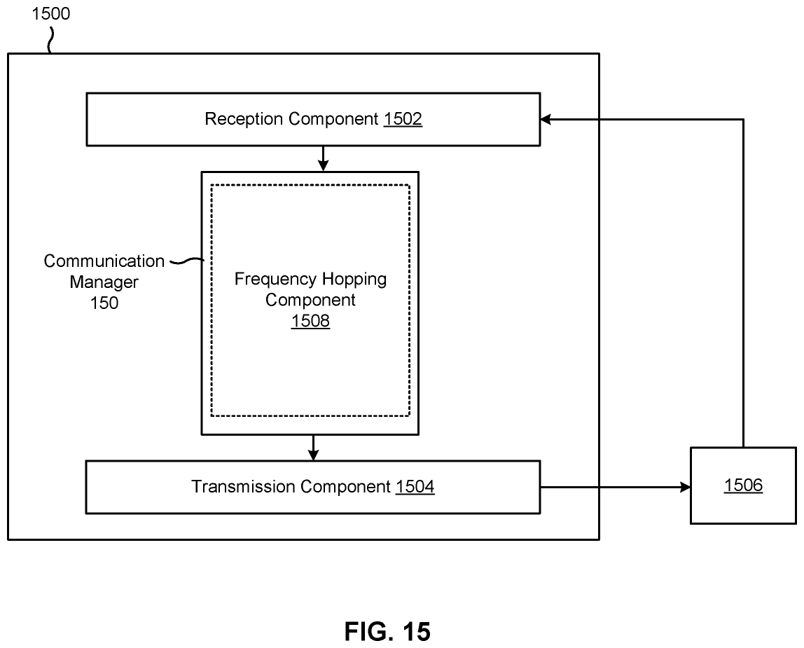

As shown in FIG. 13, in some aspects, process 1300 may include transmitting configuration information associated with configuring a set of SRS transmissions on a set of frequencies, wherein the set of SRS transmissions on the set of frequencies comprise an SRS frequency hopping pattern (block 1310). For example, the network node (e.g., using controller/processor 240, transmit processor 220, TX MIMO processor 230, MOD 232, antenna 234, communication manager 150, and/or transmission component 1504 depicted in FIG. 15) may transmit configuration information associated with configuring a set of SRS transmissions on a set of frequencies, wherein the set of SRS transmissions on the set of frequencies comprise an SRS frequency hopping pattern, as described above.

As further shown in FIG. 13, in some aspects, process 1300 may include receiving the set of SRS transmissions on the set of frequencies in accordance with the SRS frequency hopping pattern (block 1320). For example, the network node (e.g., using antenna 234, DEMOD 232, MIMO detector 236, receive processor 238, controller/processor 240, communication manager 150, and/or reception component 1502 depicted in FIG. 15) may receive the set of SRS transmissions on the set of frequencies in accordance with the SRS frequency hopping pattern, as described above.

Process 1300 may include additional aspects, such as any single aspect or any combination of aspects described below and/or in connection with one or more other processes described elsewhere herein.

In a first aspect, the SRS frequency hopping pattern is a random hopping scheme.

In a second aspect, alone or in combination with the first aspect, transmitting the configuration information comprises transmitting the configuration information via radio resource control signaling that enables or disables the SRS frequency hopping pattern on a per SRS resource or per SRS resource set basis.

In a third aspect, alone or in combination with one or more of the first and second aspects, the SRS frequency hopping pattern is indicated, by the configuration information, from a set of possible SRS frequency hopping patterns.

In a fourth aspect, alone or in combination with one or more of the first through third aspects, the SRS frequency hopping pattern is a set of statically configured SRS frequency hopping patterns or a set of dynamically configured SRS frequency hopping patterns.

In a fifth aspect, alone or in combination with one or more of the first through fourth aspects, the SRS frequency hopping pattern is based at least in part on at least one of a pseudo-random sequence, an initialization value, a time value, a slot number within a radio frame, or a symbol index of an SRS resource.

In a sixth aspect, alone or in combination with one or more of the first through fifth aspects, the SRS frequency hopping pattern spans a plurality of SRS periodicities.

In a seventh aspect, alone or in combination with one or more of the first through sixth aspects, the SRS frequency hopping pattern includes a set of possible hops, and wherein a transmission, of the set of SRS transmissions, is transmitted on a frequency, of the set of frequencies, based at least in part on a hop selected from the set of possible hops.

In an eighth aspect, alone or in combination with one or more of the first through seventh aspects, the SRS frequency hopping pattern is associated with an SRS partial frequency sounding and frequency hopping mode.

In a ninth aspect, alone or in combination with one or more of the first through eighth aspects, a starting resource block for the SRS frequency hopping pattern is based at least in part on at least one of a pseudo-random sequence, an initialization value, a time value, a slot number within a radio frame, or a symbol index of an SRS resource.

In a tenth aspect, alone or in combination with one or more of the first through ninth aspects, an initialization for a pseudo-random sequence associated with the SRS frequency hopping patterns is based at least in part on at least one of an SRS sequence identity, a radio resource control initialization parameter, a parameter associated with a maximum quantity of configured SRS frequency hopping patterns, a parameter associated with a configured quantity of frequency hopping patterns, a parameter associated with a maximum quantity of configured SRS sequence identities, a partial frequency sounding allocation parameter, or a starting resource block for partial frequency sounding.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 140. The communication manager 140 may include a frequency hopping component 1408, among other examples.

In some aspects, the apparatus 1400 may be configured to perform one or more operations described herein in connection with FIGS. 11A-11D. Additionally, or alternatively. the apparatus 1400 may be configured to perform one or more processes described herein, such as process 1200 of FIG. 12. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The reception component 1402 may receive configuration information associated with configuring a set of SRS transmissions on a set of frequencies, wherein the set of SRS transmissions on the set of frequencies comprise an SRS frequency hopping pattern. The transmission component 1404 may transmit the set of SRS transmissions on the set of frequencies in accordance with the SRS frequency hopping pattern. The frequency hopping component 1408 may control frequency hopping for the apparatus 1400.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 150. The communication manager 150 may include a frequency hopping component 1508, among other examples.

In some aspects, the apparatus 1500 may be configured to perform one or more operations described herein in connection with FIGS. 11A-11D. Additionally, or alternatively. the apparatus 1500 may be configured to perform one or more processes described herein, such as process 1300 of FIG. 13. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The transmission component 1504 may transmit configuration information associated with configuring a set of SRS transmissions on a set of frequencies, wherein the set of SRS transmissions on the set of frequencies comprise an SRS frequency hopping pattern. The reception component 1502 may receive the set of SRS transmissions on the set of frequencies in accordance with the SRS frequency hopping pattern. The frequency hopping component 1508 may control frequency hopping reception for the apparatus 1500.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving configuration information associated with configuring a set of sounding reference signal (SRS) transmissions on a set of frequencies, wherein the set of SRS transmissions on the set of frequencies comprise an SRS frequency hopping pattern; and transmitting the set of SRS transmissions on the set of frequencies in accordance with the SRS frequency hopping pattern.

Aspect 2: The method of Aspect 1, wherein the SRS frequency hopping pattern is a random hopping scheme.

Aspect 3: The method of any of Aspects 1 to 2, wherein receiving the configuration information comprises: receiving the configuration information via radio resource control signaling that enables or disables the SRS frequency hopping pattern on a per SRS resource or per SRS resource set basis.

Aspect 4: The method of any of Aspects 1 to 3, wherein the SRS frequency hopping pattern is indicated, by the configuration information, from a set of possible SRS frequency hopping patterns configured for the UE.

Aspect 5: The method of any of Aspects 1 to 4, wherein the SRS frequency hopping pattern is a set of statically configured SRS frequency hopping patterns or a set of dynamically configured SRS frequency hopping patterns.

Aspect 6: The method of any of Aspects 1 to 5, wherein the SRS frequency hopping pattern is based at least in part on at least one of: a pseudo-random sequence, an initialization value, a time value, a slot number within a radio frame, or a symbol index of an SRS resource.

Aspect 7: The method of any of Aspects 1 to 6, wherein the SRS frequency hopping pattern spans a plurality of SRS periodicities.

Aspect 8: The method of any of Aspects 1 to 7, wherein the SRS frequency hopping pattern includes a set of possible hops, and wherein a transmission, of the set of SRS transmissions, is transmitted on a frequency, of the set of frequencies, based at least in part on a hop selected from the set of possible hops.

Aspect 9: The method of any of Aspects 1 to 8, wherein the SRS frequency hopping pattern is associated with an SRS partial frequency sounding and frequency hopping mode of the UE.

Aspect 10: The method of any of Aspects 1 to 9, wherein a starting resource block for the SRS frequency hopping pattern is based at least in part on at least one of: a pseudo-random sequence, an initialization value, a time value, a slot number within a radio frame, or a symbol index of an SRS resource.

Aspect 11: The method of any of Aspects 1 to 10, wherein an initialization for a pseudo-random sequence associated with the SRS frequency hopping patterns is based at least in part on at least one of: an SRS sequence identity, a radio resource control initialization parameter, a parameter associated with a maximum quantity of configured SRS frequency hopping patterns, a parameter associated with a configured quantity of frequency hopping patterns, a parameter associated with a maximum quantity of configured SRS sequence identities, a partial frequency sounding allocation parameter, or a starting resource block for partial frequency sounding.

Aspect 12: A method of wireless communication performed by a network node, comprising: transmitting configuration information associated with configuring a set of SRS transmissions on a set of frequencies, wherein the set of SRS transmissions on the set of frequencies comprise an SRS frequency hopping pattern; and receiving the set of SRS transmissions on the set of frequencies in accordance with the SRS frequency hopping pattern.

Aspect 13: The method of Aspect 12, wherein the SRS frequency hopping pattern is a random hopping scheme.

Aspect 14: The method of any of Aspects 12 to 13, wherein transmitting the configuration information comprises: transmitting the configuration information via radio resource control signaling that enables or disables the SRS frequency hopping pattern on a per SRS resource or per SRS resource set basis.

Aspect 15: The method of any of Aspects 12 to 14, wherein the SRS frequency hopping pattern is indicated, by the configuration information, from a set of possible SRS frequency hopping patterns.

Aspect 16: The method of any of Aspects 12 to 15, wherein the SRS frequency hopping pattern is a set of statically configured SRS frequency hopping patterns or a set of dynamically configured SRS frequency hopping patterns.

Aspect 17: The method of any of Aspects 12 to 16, wherein the SRS frequency hopping pattern is based at least in part on at least one of: a pseudo-random sequence, an initialization value, a time value, a slot number within a radio frame, or a symbol index of an SRS resource.

Aspect 18: The method of any of Aspects 12 to 17, wherein the SRS frequency hopping pattern spans a plurality of SRS periodicities.

Aspect 19: The method of any of Aspects 12 to 18, wherein the SRS frequency hopping pattern includes a set of possible hops, and wherein a transmission, of the set of SRS transmissions, is transmitted on a frequency, of the set of frequencies, based at least in part on a hop selected from the set of possible hops.

Aspect 20: The method of any of Aspects 12 to 19, wherein the SRS frequency hopping pattern is associated with an SRS partial frequency sounding and frequency hopping mode.

Aspect 21: The method of any of Aspects 12 to 20, wherein a starting resource block for the SRS frequency hopping pattern is based at least in part on at least one of: a pseudo-random sequence, an initialization value, a time value, a slot number within a radio frame, or a symbol index of an SRS resource.

Aspect 22: The method of any of Aspects 12 to 21, wherein an initialization for a pseudo-random sequence associated with the SRS frequency hopping patterns is based at least in part on at least one of: an SRS sequence identity, a radio resource control initialization parameter, a parameter associated with a maximum quantity of configured SRS frequency hopping patterns, a parameter associated with a configured quantity of frequency hopping patterns, a parameter associated with a maximum quantity of configured SRS sequence identities, a partial frequency sounding allocation parameter, or a starting resource block for partial frequency sounding.

Aspect 23: An apparatus for wireless communication at a device, comprising a processor; memory coupled with the processor; and instructions stored in the memory and executable by the processor to cause the apparatus to perform the method of one or more of Aspects 1-11.

Aspect 24: A device for wireless communication, comprising a memory and one or more processors coupled to the memory, the one or more processors configured to perform the method of one or more of Aspects 1-11.

Aspect 25: An apparatus for wireless communication, comprising at least one means for performing the method of one or more of Aspects 1-11.

Aspect 26: A non-transitory computer-readable medium storing code for wireless communication, the code comprising instructions executable by a processor to perform the method of one or more of Aspects 1-11.

Aspect 27: A non-transitory computer-readable medium storing a set of instructions for wireless communication, the set of instructions comprising one or more instructions that, when executed by one or more processors of a device, cause the device to perform the method of one or more of Aspects 1-11.

Aspect 28: An apparatus for wireless communication at a device, comprising a processor; memory coupled with the processor; and instructions stored in the memory and executable by the processor to cause the apparatus to perform the method of one or more of Aspects 12-22.

Aspect 29: A device for wireless communication, comprising a memory and one or more processors coupled to the memory, the one or more processors configured to perform the method of one or more of Aspects 12-22.

Aspect 30: An apparatus for wireless communication, comprising at least one means for performing the method of one or more of Aspects 12-22.

Aspect 31: A non-transitory computer-readable medium storing code for wireless communication, the code comprising instructions executable by a processor to perform the method of one or more of Aspects 12-22.

Aspect 32: A non-transitory computer-readable medium storing a set of instructions for wireless communication, the set of instructions comprising one or more instructions that, when executed by one or more processors of a device, cause the device to perform the method of one or more of Aspects 12-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein. “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

41

What is claimed is:

1. A user equipment (UE) for wireless communication, comprising:
a memory; and
one or more processors, coupled to the memory, configured to:
receive configuration information associated with configuring a set of sounding reference signal (SRS) transmissions on a set of frequencies, wherein the set of SRS transmissions on the set of frequencies comprise an SRS frequency hopping pattern; and
transmit the set of SRS transmissions on the set of frequencies in accordance with the SRS frequency hopping pattern.

2. The UE of claim 1, wherein the SRS frequency hopping pattern is a random hopping scheme.

3. The UE of claim 1, wherein the one or more processors, to receive the configuration information, are configured to:
receive the configuration information via radio resource control signaling that enables or disables the SRS frequency hopping pattern on a per SRS resource or per SRS resource set basis.

4. The configuration information of claim 1, wherein the SRS frequency hopping pattern is indicated, by the configuration information, from a set of possible SRS frequency hopping patterns configured for the UE.

5. The UE of claim 1, wherein the SRS frequency hopping pattern is a set of statically configured SRS frequency hopping patterns or a set of dynamically configured SRS frequency hopping patterns.

6. The UE of claim 1, wherein the SRS frequency hopping pattern is based at least in part on at least one of:
a pseudo-random sequence,
an initialization value,
a time value,
a slot number within a radio frame, or
a symbol index of an SRS resource.

7. The UE of claim 1, wherein the SRS frequency hopping pattern spans a plurality of SRS periodicities.

8. The UE of claim 1, wherein the SRS frequency hopping pattern includes a set of possible hops, and wherein a transmission, of the set of SRS transmissions, is transmitted on a frequency, of the set of frequencies, based at least in part on a hop selected from the set of possible hops.

9. The UE of claim 1, wherein the SRS frequency hopping pattern is associated with an SRS partial frequency sounding and frequency hopping mode of the UE.

10. The UE of claim 1, wherein a starting resource block for the SRS frequency hopping pattern is based at least in part on at least one of:
a pseudo-random sequence,
an initialization value,
a time value,
a slot number within a radio frame, or
a symbol index of an SRS resource.

11. The UE of claim 1, wherein an initialization for a pseudo-random sequence associated with the SRS frequency hopping patterns is based at least in part on at least one of:
an SRS sequence identity,
a radio resource control initialization parameter,
a parameter associated with a maximum quantity of configured SRS frequency hopping patterns,
a parameter associated with a configured quantity of frequency hopping patterns,
a parameter associated with a maximum quantity of configured SRS sequence identities,
a partial frequency sounding allocation parameter, or
a starting resource block for partial frequency sounding.

12. A network node for wireless communication, comprising:
a memory; and
one or more processors, coupled to the memory, configured to:
transmit configuration information associated with configuring a set of sounding reference signal (SRS) transmissions on a set of frequencies, wherein the set of SRS transmissions on the set of frequencies comprise an SRS frequency hopping pattern; and
receive the set of SRS transmissions on the set of frequencies in accordance with the SRS frequency hopping pattern.

13. The network node of claim 12, wherein the SRS frequency hopping pattern is a random hopping scheme.

14. The network node of claim 12, wherein the one or more processors, to transmit the configuration information, are configured to:
transmit the configuration information via radio resource control signaling that enables or disables the SRS frequency hopping pattern on a per SRS resource or per SRS resource set basis.

15. The configuration information of claim 12, wherein the SRS frequency hopping pattern is indicated, by the configuration information, from a set of possible SRS frequency hopping patterns.

16. The network node of claim 12, wherein the SRS frequency hopping pattern is a set of statically configured SRS frequency hopping patterns or a set of dynamically configured SRS frequency hopping patterns.

17. The network node of claim 12, wherein the SRS frequency hopping pattern is based at least in part on at least one of:
a pseudo-random sequence,
an initialization value,
a time value,
a slot number within a radio frame, or
a symbol index of an SRS resource.

18. The network node of claim 12, wherein the SRS frequency hopping pattern spans a plurality of SRS periodicities.

19. The network node of claim 12, wherein the SRS frequency hopping pattern includes a set of possible hops, and wherein a transmission, of the set of SRS transmissions, is transmitted on a frequency, of the set of frequencies, based at least in part on a hop selected from the set of possible hops.

20. The network node of claim 12, wherein the SRS frequency hopping pattern is associated with an SRS partial frequency sounding and frequency hopping mode.

21. The network node of claim 12, wherein a starting resource block for the SRS frequency hopping pattern is based at least in part on at least one of:
a pseudo-random sequence,
an initialization value,
a time value,
a slot number within a radio frame, or
a symbol index of an SRS resource.

22. The network node of claim 12, wherein an initialization for a pseudo-random sequence associated with the SRS frequency hopping patterns is based at least in part on at least one of:
an SRS sequence identity,
a radio resource control initialization parameter,
a parameter associated with a maximum quantity of configured SRS frequency hopping patterns,
a parameter associated with a configured quantity of frequency hopping patterns,
a parameter associated with a maximum quantity of configured SRS sequence identities,
a partial frequency sounding allocation parameter, or
a starting resource block for partial frequency sounding.

23. A method of wireless communication performed by a user equipment (UE), comprising:
receiving configuration information associated with configuring a set of sounding reference signal (SRS) transmissions on a set of frequencies, wherein the set of SRS transmissions on the set of frequencies comprise an SRS frequency hopping pattern; and
transmitting the set of SRS transmissions on the set of frequencies in accordance with the SRS frequency hopping pattern.

24. The method of claim 23, wherein the SRS frequency hopping pattern is a random hopping scheme.

25. The method of claim 23, wherein receiving the configuration information comprises:
receiving the configuration information via radio resource control signaling that enables or disables the SRS frequency hopping pattern on a per SRS resource or per SRS resource set basis.

26. The method of claim 23, wherein the SRS frequency hopping pattern is indicated, by the configuration information, from a set of possible SRS frequency hopping patterns configured for the UE.

27. A method of wireless communication performed by a network node, comprising:
transmitting configuration information associated with configuring a set of sounding reference signal (SRS) transmissions on a set of frequencies, wherein the set of SRS transmissions on the set of frequencies comprise an SRS frequency hopping pattern; and
receiving the set of SRS transmissions on the set of frequencies in accordance with the SRS frequency hopping pattern.

28. The method of claim 27, wherein the SRS frequency hopping pattern is a random hopping scheme.

29. The method of claim 27, wherein transmitting the configuration information comprises:
transmitting the configuration information via radio resource control signaling that enables or disables the SRS frequency hopping pattern on a per SRS resource or per SRS resource set basis.

30. The method of claim 27, wherein the SRS frequency hopping pattern is indicated, by the configuration information, from a set of possible SRS frequency hopping patterns.
